(19) United States
(12) Patent Application Publication
(10) Pub. No.: US 2023/0405618 A1
(43) Pub. Date: Dec. 21, 2023

(54) Device for spraying media on the inner sides of medical products

(71) Applicant: HEKUMA GmbH, Eching (DE)

(72) Inventor: Michael HUBER, Eching (DE)

(21) Appl. No.: 18/038,137

(22) PCT Filed: Dec. 7, 2021
(86) PCT No.: PCT/EP2021/084579

§ 371 Date: May 22, 2023

(30) Foreign Application Priority Data
Dec. 10, 2020 (DE) 102020132999.7

(51) Int. Cl. B05B 7/06; B05B 13/06

(52) U.S. Cl. CPC B05B 7/066; B05B 13/069

(57) ABSTRACT

Device (10) for spraying or applying of media by means of compressed air, in particular at insides or inner sides of medical products or vessels, with a two-substance nozzle (1) formed from at least two cannulas (2, 3) inserted one in the other with substantially constant diameter along their longitudinal extension, with a nozzle body (4) formed as a holding means for the two-substance nozzle (1), which has at least in each case an inlet for the medium (11) and for the compressed air (12), wherein at the nozzle body (4), clamping inserts (5, 6) respectively adapted in shape to receiving means (7, 8) are arranged for a sealingly holding and fixedly holding of an inner cannula (2) for media and of an outer cannula (3) for compressed air in the form of hollow needles, which are provided in the correspondingly shaped receiving means (7, 8) for attaching the cannulas (2, 3) inserted one in the other with the formation of a predefined gap (14) between inner cannula (2) and outer cannula (3).

The present invention relates to a device for spraying or applying of, for example, fluid media on surfaces by means of compressed air supply or by means of a pressurized gas in particular for medical products, like for example the insides of medical vessels or the like. In medicine technology, automatized systems are needed for different medical products by means of which media must be applied on insides of the products, like for example pipettes, syringes or glass vessels like test tubes. For example for determined medical products, in automation systems the inner surface of such vessels is coated with media in the form of, for example, means dissolved in water or suspensions like heparin, BCA or EDTA, before they can be further processed for the completing of the product.

A problem in such devices known up to now for the spraying or applying of media within such vessels or medical products consists in that, frequently, an uneven distribution of the media at the surface occurs, because the dosing in narrow inner areas is difficult. According to the known principle of a conventional two-substance nozzle, the fluid (medium) is entrained by compressed air with turbulent flows upon discharge of the compressed air and distributed as droplets on the surface of the vessels. In the known two-substance nozzles of this kind, however, there is a problem to the effect that, in the relatively narrow spatial conditions of the vessels, the nozzles often have too large dimensions and the emerging compressed air has to flow out again, which then takes place at higher flow speeds. Due to this faster-flowing compressed air, already-sprayed coating droplets are entrained again from the wall of the vessel, so that the coating with the medium is destroyed or irregular.

Furthermore, there is a problem to the effect that, with the devices or automation systems of this kind up to now, it was not easy to realize the uniformity of the distribution of the media and an adjustable spraying area within the surfaces of such medical products. Not least, there was a problem to the effect that the spraying of different media like liquids is not so easy to achieve, because the inner areas of the surfaces of the medical products, which surfaces are to be processed, often have a relatively small diameter and conventional two-substance nozzles cannot be moved into there.

In view of the above, it is the object of the present invention to provide a device for spraying or applying of media by means of compressed air supply or pressurized gas supply, in particular at insides or inner sides of medical products or vessels, by means of which an as exact and precise as possible distribution of the medium to be applied is made possible, and by means of which a precise adjustability of the spraying area within inner surfaces of such products or vessels is possible. Furthermore, it is the object of the present invention to provide a device constructed as simply as possible for such cases of application in the medical field for the spraying of media, which also allows a quick change of media to be applied and of spray nozzles to be inserted and used.

This object is solved by means of a device having the features of claim 1. Advantageous embodiments and developments of the invention are the subject matter of the dependent claims.

According to the present invention, a device is proposed for spraying or applying a medium by means of compressed air supply or by means of another auxiliary gas, like for example inert gas under pressure, which is formed and adapted in particular for a spraying or applying of the media at insides or on inner sides of medical products or narrow vessels and which has a two-substance nozzle made from at least two cannulas inserted one in the other with substantially constant diameter along the longitudinal extension thereof, with a nozzle body formed as a holding means for the two-substance nozzle, which has at least in each case an inlet for a medium and for the auxiliary gas, wherein the device is characterized by a nozzle body which has receiving means and respective clamping inserts adapted to the receiving means for a sealed holding and fixedly holding of an inner cannula and an outer cannula for example in the form of hollow needles, wherein the clamping inserts are provided at the nozzle body for attaching the cannulas inserted one in the other with formation of a predefined gap between inner cannula and outer cannula. According to the invention, therefore, a device is provided which essentially consists of two cannulas in the form of an inner cannula and an outer cannula, which are fixedly held in a nozzle body, namely a central holding element. The two cannulas inserted one in the other are in each case fixedly held in the nozzle body in the form of clamping inserts. Hereby, the inner cannula and the outer cannula are inserted one in the other such that a ring gap with predefined dimensions is formed between them, by means of which the compressed air or another auxiliary gas can flow out and at the same time a medium flows out through the inner cannula. This form of a two-substance nozzle with two cannulas inserted one in the other minimizes the influence by the reduced speed of the compressed air flowing out. Due to the reduced flow speed of the air, already-applied droplets at the inner walls of the vessels are prevented from being entrained again and removed. The correspondingly-shaped receiving means in the nozzle body are hereby formed such that, by means of the clamping inserts, the cannulas inserted one in the other in each case can be inserted and sealingly fixedly held. The clamping inserts have the advantage that an automatic centering and sealing of the respective areas of the compressed air and for the supply of the medium, is guaranteed.

The two cannulas inserted one in the other have a substantially constant diameter and thus a constant cross-section along the longitudinal extension at least in the direction toward the discharge end of the device. That means that the two cannulas, namely the inner cannula and the outer cannula, are formed with a simple thin tube in each case with corresponding dimensions, without there being a tapering or narrowing for example at the discharge end of the cannulas. In this way, a predefined ring gap is formed between the inner cannula and the outer cannula surrounding it. The predefined ring gap has the predetermined dimensions and in particular the substantially constant distance between the inner cannula and the outer cannula, and is determined and centered in position and location by means of the fixedly holding of the cannulas in the nozzle body by means of the clamping inserts.

The inner cannula and outer cannula, inserted one in the other in this way with the defined ring gap, also allow a kind of self-centering effect by means of the compressed air or the pressurized gas (auxiliary gas) flowing between outer cannula and inner cannula and flowing back in the vessel. By means of a relatively small thickness of the cannulas and correspondingly small wall thickness of the inner cannula and outer cannula, the two cannulas are admittedly in principle displaceable and movable in relation to one another. During flowing out of the medium through the inner cannula and parallel supply of compressed air through the ring gap in the vessel a kind of centering is obtained between the two cannulas, which allows a defined and correctly dosed spray pattern during the discharging of the media. Therefore, when the device is in use, the inner cannula and the outer cannula are always arranged at a determined distance, which is determined by their diameter, to one another and also to the inner walls of the vessels. Both cannulas are orientated centered in relation to the middle axis X of the device and nevertheless allow a relatively deep penetration of the device into the vessels and products to be treated, due to the slender construction. The predefined ring gap, which is important for an exact dosing, is thus always guaranteed in use during production of the compressed air or supply of another pressurized gas (for example inert gas), without the individual cannulas having to be additionally secured or held at intermediate positions or at the discharge end.

Advantageously, the inner cannula and the outer cannula are inserted one in the other such that they are aligned or flush with one another at the discharge end. Alternatively, the outer cannula or the inner cannula can also be adjusted slightly protruding in relation to the other cannula respectively. This allows further variations and changes to the desired, clearly defined spraying pattern or spraying profile with the medium at the inner walls of the vessels to be treated.

Also, the device according to the invention formed in this way with a two-substance nozzle formed of two cannulas inserted one in the other allows a quick change of the elements, for example for cleaning or for changing the penetration depth (length of the cannulas). In this way, for example differently long or differently thick cannulas can be inserted in one and the same device by a simple exchanging of the respective clamping inserts with the hollow needles of the cannulas. Also, the device formed in this way allows an improved spraying or applying of medical products at their usually relatively narrow inner areas. With the device, the inner surfaces of for example syringes, pipettes, glass tubes or the like can easily be effectively sprayed with a medical product, wherein very uniform distributions in axial and in radial direction are made possible with the device. The amount of the sprayed media or fluids can therefore be exactly adjusted. Furthermore, with the device according to the invention it is also possible to determine a specific area at the inner surfaces of such medical vessels or products onto which the product is to be sprayed.

By means of the clampingly holding of the clamping inserts connected with the cannulas in the corresponding receiving means at the nozzle body, the invention furthermore allows a secure fixation even of relatively thin-walled cannulas which can be used for the spraying of such media. The cannulas of the inner cannula and of the outer cannula of the two-substance nozzle are fixedly held at predefined centered positions at the nozzle body by means of the clamping inserts. Furthermore, in this way, it is possible to connect the further connections for compressed air and for the supply of media at the nozzle body in a simple manner, for example by means of a dosing pump, even though the two-substance nozzle with the cannulas has a relatively slender construction. With the device according to the invention, in this way even very different uses in the medical field for the coating of such inner surfaces of products can be easily realized. In this way, different shapes of inner cannulas and outer cannulas can be easily fixedly held by the clamping inserts at one and the same central nozzle body. A quick changing is thus likewise guaranteed and possible, as is also a quick assembly of the two-substance nozzle. Also, this construction according to the invention allows an easier and quicker cleaning of the elements, for example when changing to a different medium. The cannulas and the nozzle body can be completely disassembled.

According to an advantageous embodiment of the invention, the clamping inserts of the nozzle body have a conically tapered shape, and the nozzle body itself has respective correspondingly shaped conical receiving means. Thus the nozzle body has conically formed receiving means for the inserting of the likewise conically tapered clamping inserts. The conically tapered shape of the receiving means and of the clamping inserts has the advantage that an automatic sealing and at the same time centering in relation to a longitudinal axis (middle axis X) of the two-substance nozzle is guaranteed. With the clamping inserts, due to the form-fitting, a ring gap between the cannulas is also obtained in this way and a secure sealing without the necessity of additional seals. The compressed air and the media are thus securely sealed against a leak. With the conicity of the receiving means and of the clamping inserts for fixedly holding and attaching the inner cannulas and the outer cannulas, a kind of force-fitting connection of the cannulas in the clamping inserts and in the nozzle body is produced. The cannulas are fixedly held at the intended location and position due to the pressing force and the conic shape of the receiving means and the clamping inserts. Furthermore, by means of the force-fitting connection in the conical receiving means/clamping inserts, a secure sealing of the inner areas of the device is obtained, as a relatively extensive or widespread force-fitting connection takes place at these conical shapes. The conically tapered shape can have a linear conicity or a curved conicity. The receiving means have in each case corresponding counter-shapes with the shape adapted to the clamping inserts. Advantageously, according to a further aspect of the invention, the conicity of the receiving means can also be slightly different from that of the clamping inserts, so that a linear sealing place is obtained by fixedly clamping or press-locking of the clamping inserts in the receiving means.

According to a further advantageous embodiment of the invention, the cannulas of the two-substance nozzle inserted one in the other are relatively thin-walled hollow needles with a wall thickness of 20 to 30% of the inner diameter of the cannulas. Advantageously according to the invention, it has been shown that, with such thin-walled hollow needles, a very exact spraying of media is made possible even for narrow vessels or medical products. Hollow needles are also meant in the present case that do not have any tapering at the front end, rather, they are simple, thin, cylindrical tubes. The thin-walled hollow needles have the advantage that they allow a spraying of the media even over a relatively long area in the narrow inside of, for example, syringes or glass vessels for medical products, for a nevertheless relatively exact dosage of the amount of the sprayed-on media. Furthermore, due to the comparatively thin shape of the hollow needles there is an advantage to the effect that the emerging compressed air during spraying of the media has enough space, even in narrow vessels, to flow out again. In this way, the flow speeds of the compressed air in the inside of the vessels are clearly reduced in relation to that of devices of this kind known up to now, so that it does not come to a tearing-off again of already-applied droplets at the vessel inner walls. The thin-walled hollow needles have the advantage that they cause a kind of self-centering in connection with the compressed air. Therefore, in the spraying condition, despite the thin-walled cannulas, the two-substance nozzle is always in a middle, centralized area during applying and spraying of the media within the inside area of such medical vessels. The thin-walled hollow needles furthermore have the advantage that a very deep insertion and penetration into such hollow vessels of medical products is made possible. With conventional spray nozzles (two-substance nozzles) with a relatively large outer diameter this is not possible in this way.

According to a further advantageous embodiment of the invention, the ring gap for compressed air or inert gas between the inner cannula and the outer cannula of the two-substance nozzle has a dimension and gap width of less than 10%, preferably 6%, of the diameter of the inner cannula. A relatively narrow ring gap for the compressed air or a pressurized inert gas has the advantage that a sufficient vaporization of the fluid medium from the inner cannula takes place and a good distribution of the sprayed-out small droplets of the media is made possible. Therefore, a very exact dosage of the amount of applied media at the inner surfaces of the medical vessels is possible. Furthermore, the small ring gap for compressed air has the advantage that a precise, small droplet size for the media can be set. The width of the ring gap defines the droplet size, while the amount of compressed air is variably adjustable in each case by means of the vaporization pressure of the compressed air, in order to have as far as possible a not too high flow speed of the compressed air during flowing out from the inside area of the vessels. Therefore, with regard to its dimension, the ring gap according to the invention is adaptable to the respective conditions and requirements in a simple manner, for example in its width by means of different cannula diameters. By means of a nozzle part formed in this way with inner cannula and outer cannula and ring gap, it is achieved that an even distribution of the media with sufficiently strong compressed air takes place, without the coating in the narrow inner areas of the vessels being destroyed again.

According to a further advantageous embodiment of the invention, the clamping inserts of the nozzle body and at least one of the clamping inserts are mounted or fixedly held at the nozzle body by means of clamp caps, in particular by means of clamp caps provided with a thread. In this way, the clamping inserts with the clamping effect can be easily assembled and disassembled simply by means of threadedly connecting the clamp caps at the nozzle bodies together with the cannulas provided in them, namely the inner cannula for medium and the outer cannula for compressed air. This is also necessary, for example, in order to allow a cleaning of the device when changing the medium to be applied. Furthermore, in this way the secure sealing of the different areas can be easily realized by means of the clamping inserts, by simply threadedly connecting the clamp caps securely onto the receiving means with the clamp caps. Alternative fixedly holdings of the caps for fixedly holding the clamping inserts in the nozzle body can be provided, like for example retention springs, latching snap-locks or bayonet locks.

According to a further advantageous embodiment of the invention, the inner cannula and the outer cannula of the two-substance nozzle are arranged aligned or flush in relation to each other at their respective front discharge end. The front end, namely the discharge end for compressed air, and the discharge end for media are thus realized in a plane. In this way, a good mixing between on the one hand the fluid medium and on the other hand the compressed air is obtained. Directly at the front discharge end of the two-substance nozzle, the media are well mixed in cooperation with the inner space and bottom of the vessel, and thus allow an exact application and spraying of medical media of this kind without complex controlling of the dosing pump and actuators. In the case of very deep inner areas of vessels, alternatively actuators can also be used for the travel paths of the two-substance nozzle according to the invention, wherein then a control can be provided for the actuation of the actuators in cooperation with the activation of the pump. Alternatively to this embodiment of the invention, the inner cannula and the outer cannula can also be provided adjustably with a slight protrusion in relation to one another. For example, the inner cannula can be provided with a slight protrusion of 0.2 mm in relation to the outer cannula, so that in this way further advantages and specific effects can be obtained when discharging and applying the media. Conversely, the inner cannula can also be slightly set back in relation to the outer cannula, which can have a protrusion of for example 0.2 mm to mm. In this way, different nozzle effects at the outlet place/exit point of the discharge ends of the inner cannula and of the outer cannula according to the invention can be easily realized, by simply changing the location or position in relation to one another of the cannulas inserted one in the other.

According to a further advantageous embodiment of the invention, the relative location of front discharge ends of the inner cannula and of the outer cannula is adjustable. With a location adjustable in this way, for example the inner cannula can be adjusted with a slight protrusion in relation to the outer cannula, for example in the range of 0.1 mm to 0.3 mm, preferably 0.2 mm, by simple relative displacement. Also, conversely with such an adjustable relative location of the two cannulas, the outer cannula can be arranged with slight protrusion in relation to the inner cannula, without anything having to be changed in a complex manner at the construction. In this way, different effects and spraying profiles for different conditions and different kinds of vessels and medical products, can be effectively adjusted and considered.

According to a further advantageous embodiment of the invention, in the central nozzle body of the two-substance nozzle of the device, a hollow space is present for the supplying of compressed air or inert gas into the two-substance nozzle. Therefore, the nozzle body according to the invention is an element provided in the inside with a hollow space which is supplied with compressed air or with another auxiliary gas by means of a compressed air connection, wherein the hollow space is in flow connection with the ring gap between inner cannula and outer cannula. Therefore, the compressed air with sufficient amount and a sufficiently high pressure can be securely guided through the substantially very thin intermediate spaces between inner cannula and outer cannula (gap between hollow needles). An exact, quick discharge and vaporization with the two-substance nozzle is therefore guaranteed at all times. After a connecting of both the compressed air at the connection for compressed air of the nozzle body and of the connection for media on the side of, for example, a dosing pump, an exact dosage and an exactly defined application of the required amount of active ingredients in the inner surfaces of the medical products can be guaranteed. Also, in this way, with the nozzle body a compact and nevertheless simply constructed central element for the holding of the individual components, namely the inner cannula, the outer cannula, the clamping inserts and the connection elements for compressed air and media, is given.

According to a further advantageous embodiment of the invention, the hollow needles of the inner cannula and of the outer cannula are thin-walled hollow needles with wall thicknesses in the range of between 0.1 mm and 0.5 mm. The air needle and dosing needle formed in this way, which consist of individual cannulas inserted one in the other with relatively thin wall thicknesses, are thus suitable for allowing an applying of active ingredients or media even in deeper-lying areas of inner spaces of medical vessels. The relatively thin two-substance nozzles can be well moved even into very narrow areas and exactly adjusted there to the spraying of the media applied under pressure. With such relatively thin-walled cannulas according to the invention it has been shown in a surprising manner that a kind of self-centering automatically takes place in the inside of the vessels. During the applying of media under pressure, the front end, the discharge end of the two-substance nozzle, is always held by the emerging compressed air substantially in a middle location and position, that is, effectively centered due to the thin-walled form of the two hollow needles. Therefore the two-substance nozzle is shown to be particularly suitable for the applying of active ingredients inside of medical vessels and products, like for example syringes, pipettes, tubes or the like.

According to a further advantageous embodiment of the invention, at the nozzle body a connection for compressed air or another pressurized auxiliary gas is provided arranged laterally, that is, transverse to the medium line in relation to the longitudinal direction of the cannulas. The nozzle body and the two-substance nozzle altogether can in this way be formed very compact according to the invention. The media connection provided for example at a rearward side can be connected directly with the inner cannula at the clamping insert, while the compressed air connection can be provided laterally at the nozzle body without conflict with the media connection. Extra passages or lines in the nozzle body are not required. Therefore, the two-substance nozzle is also suitable for a quick change between different media, in that the connection for media is changed between a line or another line. The compressed air connection, which is located transverse at a lateral area of the nozzle body, can thereby remain unchanged, as even for different media the compressed air connection does not necessarily have to be changed.

According to a further advantageous embodiment of the invention, the clamp cap at the front end is formed, on the side of the protruding cannulas, outside tapered conically towards the front. At the ends facing the discharge end of the two-substance nozzle, therefore, the clamp cap for the outer cannula and the clamping insert of the outer cannula is tapered conically towards the front. This facilitates a deeper penetration in hollow spaces of medical vessels or products. Furthermore, in this way a disturbance of the air flow of the compressed air emerging from the vessel during applying of the media is avoided. The compressed air and residue of the superfluous media can flow quasi without resistance out of the inside of the vessel, even in narrowed conditions of inner spaces. Not least, this form has the advantage that the maximum penetration depth of the two-substance nozzle is increased further. According to a further advantageous embodiment of the invention, the clamping inserts of the two-substance nozzle are altogether adapted and formed for the centering of the cannulas in relation to a middle axis X of the nozzle body and of the device. The clamping inserts and the corresponding receiving means for the clamping inserts at the nozzle body are formed such that the cannulas fixedly held therein, namely the air needle (outer cannula) and the dosing needle (inner cannula) for media, are exactly centered in relation to a middle axis X of the nozzle body automatically during insertion. Therefore, besides the holding function and the sealing function, the clamping inserts also have an advantageous centering function. With the automatic centering, the hollow needles of the inner cannula and of the outer cannula are fixedly held one in the other in their relative position such that they form a predefined ring gap between them, through which the compressed air for the spraying of the media can flow out. Therefore, no complex processing of the parts of the two-substance nozzle is required for the manufacturing of nozzle passages or the like in order to obtain a predefined form of the nozzle body and of the cannulas. With the simple insertion of the clamping inserts in receiving means provided concentrically in relation to one another and clamping inserts at the nozzle body, the cannulas are automatically also centered at the same time.

According to a further advantageous embodiment of the invention, a displacement unit for displacement of the relative position between the cannulas or of the position of the cannulas altogether, is provided at least one of the inner cannula and the outer cannula. The displacement unit can, for example, be realized as a linear actuator or a servomotor which engages at a holding element of the cannulas, and the displacement unit can therefore be changed as to its relative position. With such a displacement unit according to the invention variable spray patterns of the medium to be applied can be produced. For example, according to the position and relative location in the vessel to be treated, the relative position between inner cannula and outer cannula can be precisely changed in order to obtain a larger spray amount or another spray radius of the sprayed-out medium. With such a measure, variable spray characteristics can be realized during the applying of the medium. The displacement of the relative location of the cannulas in relation to one another by means of the displacement mechanism, can also be realized for example in connection with the vertical stroke of the device altogether during moving into and moving out of the inner space of the medical vessels. For example, in a first lower area a stronger spraying than in an upper area can be adjusted, by changing the respective cannulas with the displacement unit according to the invention relatively to one another in their location in the course of the vertical stroke. Such a displacement unit can for example be realized as a servomotor, screw bracket or linear drive. Preferably, the displacement unit is integrated in a part of the holding cap for the cannulas or in a holding element for the holding of the cannulas. The displacement unit can also be built into and integrated in the nozzle body itself.

According to a further advantageous embodiment of the invention, by means of a holding cap with a displacement element which is displaceable in longitudinal direction of a middle axis X of the device, at least one of the clamping inserts is fixedly held at the nozzle body such that the relative position between the cannulas is changeable. At least one of the caps for fixedly holding the clamping inserts of the inner cannula and the outer cannula is therefore fixedly held at the nozzle body by means of a specific holding cap. This holding cap has a displacement element with which the relative position of the respective cannula is changeable. Thus for example an inner cannula can be displaced in relation to the outer cannula by means of a simple activation of the displacement element at the holding cap. In this way, quasi a kind of holding of at least one of the clamping inserts for the cannulas is provided, which allows a displacement possibility for adapting to different conditions and spray profiles or spray characteristics. The displacement possibility formed in this way also has advantages in view of a cleaning of the device. For example, when deposits from the medium settle at the discharge end of inner cannula and outer cannula, a precise cleaning can take place by means of a relative displacement between inner cannula and outer cannula, by detachment of the residues. Besides such a cleaning function, in this way a dosing operation can also be realized with the device according to the invention: by moving, for example, the inner cannula forward in relation to the outer cannula, a precise dosing of the medium alone can take place without a spraying of the medium, for example by temporarily switching off the supply of compressed air (vaporization air). Also, instead of a simple dosing operation, with this a specific adaptation of the spray pattern can be realized such that a variable application of the medium at the inner walls of the vessels can be realized in different areas.

According to a further advantageous embodiment of the invention, the clamping inserts in the receiving means of the nozzle body are fixedly held centered and sealingly by means of holding caps, which are held with a resilient spring, a bayonet lock or a latching snap-lock at the nozzle body. The holding caps are therefore not necessarily provided as clamp caps with a threaded connection according to the invention. Instead of clamp caps, holding caps can be provided which are held by means of a spring element or another latching snap-lock element at the nozzle body. With a spring or a spring element, a kind of clamping effect can be provided instead of a threaded clamp cap which produces a defined contact pressure for the holding of the cannulas at the nozzle body. Such a spring can for example be inserted between the nozzle body and a receiving area of the holding caps. Different kinds of springs are known to the skilled person in the technical field as suitable for this. Alternatively, a bayonet lock or a latching snap-lock can also be used for the fixedly holding of the holding caps at the nozzle body. In contrast to a threaded holding of the holding caps at the nozzle body, these embodiments have the advantage that a quick mounting and dismounting of the individual parts, in particular of the cannulas, out of the nozzle body is made possible. This has advantages when converting from one kind of cannula to another kind of cannula with a different length or diameter or for example also for cleaning purposes. The respective component parts and in particular the cannulas can be very quickly removed and mounted again at the nozzle body, even without tools. Such holding caps with clamping function by means of springs or by means of bayonet lock or snap locks can also be simply manufactured according to the invention, for example as injection molded parts which are easily realizable with the corresponding material characteristics for the necessary spring action of the fixedly holding at the nozzle body. A cost-effective and application-friendly form of the devices is given in this way.

According to a further advantageous embodiment of the invention, at least one of the cannulas at the clamping inserts is fixedly connected, in particular by a flanging, a crimping or a bonding, with an end-side holding means. A fixedly holding of the inner cannula or the outer cannula in the respective clamping inserts is therefore guaranteed in the nozzle body. A slipping or shifting of the individual cannulas is effectively avoided in this way. The fixedly holding or the holding means in the form of a flanging can for example be realized as a bending at the inner (rearward) end of the cannulas in the nozzle body. Also, another kind of the fixedly holding of the cannula in the clamping inserts can be provided, for example by crimping or by bonding with the clamping inserts, so that the relative position of at least one of the cannulas is fixedly held. Nevertheless, the outer cannulas as well as the inner cannulas have a substantially constant cross-section and diameter along the longitudinal extension, as already explained above with regard to claim 1. Other alternative forms of the fixedly holding of the cannulas in the clamping inserts can also be used. For example, a press-fitting of the cannulas in the material of the clamping inserts can be provided. Releasable kinds of the fixedly holding, for example by means of threads or screw elements, are likewise thinkable in the scope of the present invention.

According to a further advantageous embodiment of the invention, in the inside of the nozzle body, for example in the hollow space in the nozzle body, there is provided an air guide- or flow directing element for the compressed air or the pressurized inert gas. A flow directing element, which is provided for example between the inlet at the nozzle body and the inner (rearward) end of the outer cannula, has the advantage that the flow of the compressed air is applied very evenly around the ring gap between the outer cannula and the inner cannula, with same pressure distribution. This improves the supply and guarantees an even production of compressed air in the inside of the ring gap. In this way, the self-centering effect caused by the function and construction of the two cannulas inserted one in the other is even further improved. By means of the air flow being evenly introduced and harmonized in flow speed in the inside of the nozzle body, the location and position of the inner cannula and of the outer cannula are in this way securely centered also at their free end, in order to maintain the shape of the predefined ring gap also for the most exactly-dosed possible application of the medium. Other forms of flow elements can also be provided in the inside of the nozzle body in the area of the supply of compressed air or pressurized gas: for example, air guide elements or passages can be provided. A flow directing element according to the invention advantageously has a tubular, constant cross-section as a kind of sleeve element. Other forms of flow directing elements can also be used. With such measures, the shape and the distribution of the compressed air can easily be precisely adapted for the clearly defined production of the vaporized fluid corresponding to the pre-givens and requirements in each case. In this way, with corresponding simple means, a kind of nozzle effect of the device can already be brought about in the inside of the nozzle body or can be varied according to requirement.

According to the present invention, according to claim 19 a device for spraying or applying of fluid media with compressed air supply or by means of a pressurized gas, like inert gas, is proposed, which is in particular formed and adapted for a spraying or applying of the media at insides of medical products or narrow vessels, and which has a two-substance nozzle formed from at least two cannulas inserted one in the other with substantially constant diameter along their longitudinal extension, with a nozzle body formed as a holding means for the two-substance nozzle, which has at least in each case an inlet for the medium and for compressed air or pressurized inert gas, wherein the device is characterized by a nozzle body which in the form on receiving means has in each case adapted clamping inserts for a sealed holding and fixedly holding of an inner cannula for media and of an outer cannula for compressed air or inert gas in the form of hollow needles, wherein the clamping inserts are provided at the nozzle body for attaching the cannulas inserted one in the other with the formation of a predefined gap between inner cannula and outer cannula in the correspondingly-shaped receiving means of the nozzle body. According to the invention, in this way a device is provided which consists substantially of two hollow needles in the form of an inner cannula and an outer cannula, which are fixedly held in a nozzle body, namely a central holding element. The two cannulas inserted one in the other are in each case fixedly held in the nozzle body in the form of clamping inserts. The inner cannula and the outer cannula are hereby inserted one in the other such that a ring gap with predefined dimensions is formed between them, by means of which the compressed air or another pressurized gas can flow out with at the same time flowing out of a medium through the inner cannula. This form of a two-substance nozzle with two cannulas inserted one in the other minimizes the influence by the reduced speed of the out-flowing compressed air. By means of the reduced flow speed of the air, it is prevented that already-applied droplets at the inner walls of the vessels are entrained again and removed. The receiving means with corresponding shape in the nozzle body are hereby formed such that by means of the clamping inserts the cannulas inserted one in the other in each case can be inserted and sealingly fixedly held. The clamping inserts have the advantage that an automatic centering and sealing of the respective areas of the compressed air and for the supply of the medium is guaranteed.

Further features, aspects and advantage embodiments of the invention are described in more detail in the following by means of different embodiments of the invention with regard to the attached drawings and the Figures included therein, wherein

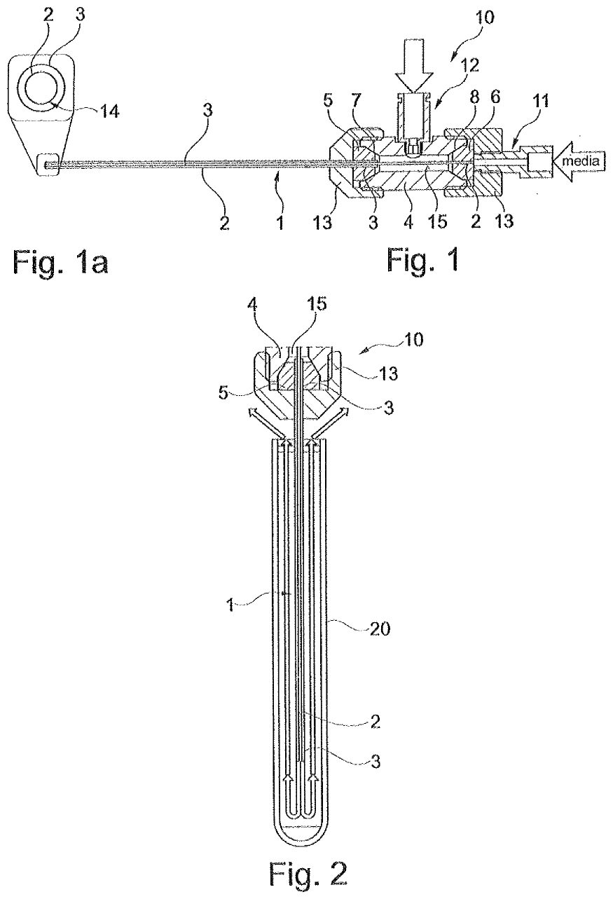

FIG. 1 shows a cross-sectional view of a first embodiment of a device according to the invention with a detailed view in a front view according to FIG. 1a;

FIG. 2 shows a sectional view of an embodiment of a device according to the invention for the spraying of media in a case of application at a medical vessel for illustrating the way of functioning of the two-substance nozzle with hollow needles inserted one in the other;

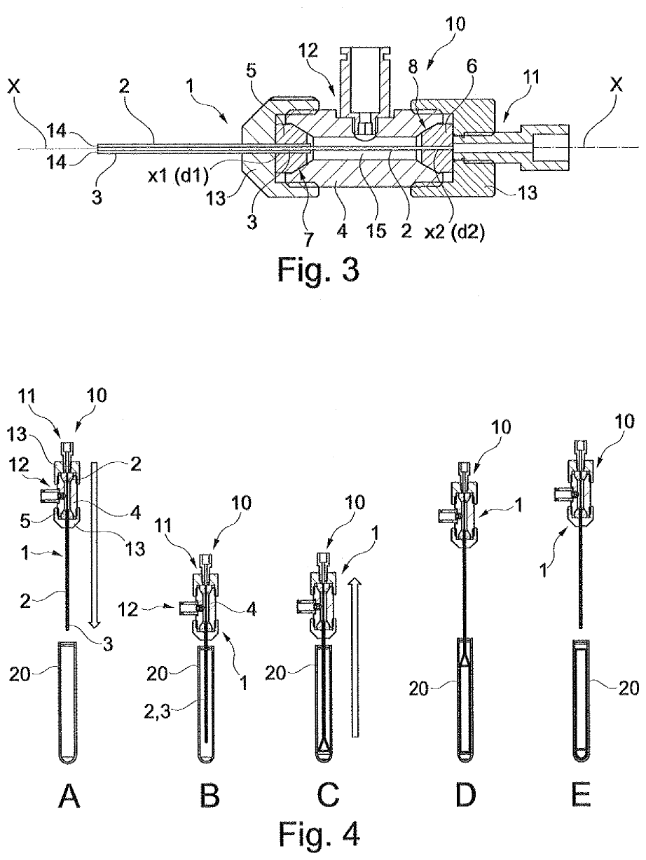

FIG. 3 shows an enlarged cross-sectional view of the first embodiment of the device according to the invention in the area of the nozzle body with clamping inserts for the inner cannula and the outer cannula and connections for compressed air supply and medium supply;

FIG. 4 shows a plurality of views of the sequence of the method for the applying of media with the embodiment according to the invention of a device with two-substance nozzle according to FIGS. 1 to 3 at an example of a medical vessel with the steps A) to E);

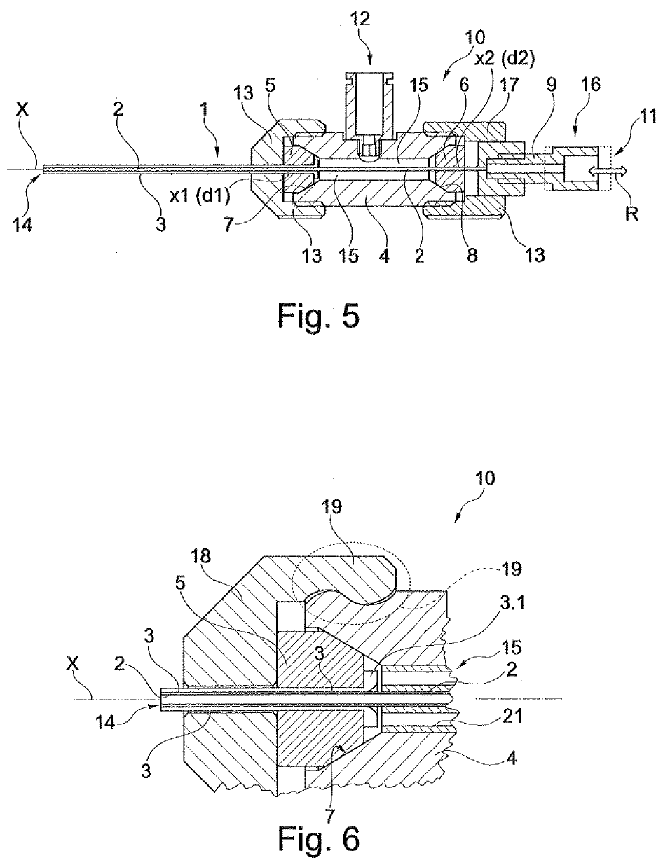

FIG. 5 shows a cross-sectional view of a second embodiment of a device according to the invention with displacement unit for the displacement of the relative position between inner cannula and outer cannula;

FIG. 6 shows a partial cross-sectional view of a third embodiment of a device according to the invention with a latching snap-lock for the fixedly holding of the holding caps for the clamping inserts of the cannulas;

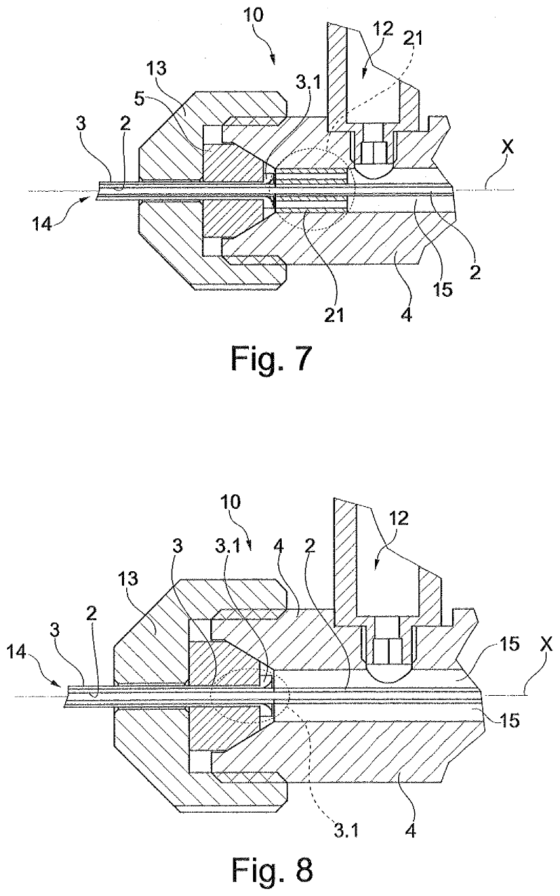

FIG. 7 shows a partial cross-sectional view of a fourth embodiment of a device according to the invention with a flow directing element for compressed air or pressurized gas; and

FIG. 8 shows a partial cross-sectional view of a fifth embodiment of a device according to the invention with a holding means provided as a flange at the outer cannula.

In FIG. 1 and the emphasized part thereof in enlarged detailed view in FIG. 1a, a first embodiment of a device 10 according to the invention for spraying or applying of fluid media on surfaces using compressed air with a two-substance nozzle 1 is shown in a cross-sectional view, wherein in FIG. 1a the front discharge end is represented enlarged in a plan view for illustrating the two-substance nozzle 1 formed from cannulas 2, 3 inserted one in the other with a ring gap 14. The device 10 in this embodiment comprises a central nozzle body 4, which together with the cannulas 2, 3 substantially forms the two-substance nozzle 1. The cannulas 2, 3 formed as thin-walled hollow needles, namely the inner cannula 2 and the outer cannula 3, are fixedly held at the nozzle body 4 in clamping inserts 5 provided for this purpose. The outer cannula 3 is inserted at the left end in FIG. 1 with the clamping insert 5 in a correspondingly formed receiving means 7 of the nozzle body 4, and sealingly and centered fixedly held there. For this, clamp caps 13 are respectively provided at the clamping inserts 5, 6 for the two hollow needles 2, 3, which are fixedly held at the nozzle body by threaded connection and thereby fixedly and sealingly hold the clamping inserts 5, 6 in the respective receiving means 7, 8.

The inner construction of the two-substance nozzle 1 of the device 10 is also shown again in an enlarged view of this embodiment in FIG. 3. A connection 12 for compressed air is provided at the nozzle body 4 laterally, that is, transverse to the longitudinal direction of the two-substance nozzle 1. At the inlet 12 for compressed air, a compressed-air-fitting in this embodiment is threadedly engaged in the nozzle body 4, which is periodically supplied in a controlled manner with compressed air by means of a pressurized air supply (not shown in detail). The front end of the compressed air inlet 12 leads into an inner hollow space 15 in the nozzle body 4, from which the compressed air flows on into the ring gap 14 between the inner cannula 2 and the outer cannula 3. At the rearward end of the two-substance nozzle 1 (on the right in FIG. 1), a threaded connection at an inlet 11 for media is shown. By means of this media connection 11, a fluid medium, for example a medical product like Heparin or the like, is introduced into the two-substance nozzle. The media supplied by means of a dosing pump (not shown) are supplied in this way to the two-substance nozzle 1 of the device 10 and, together with the compressed air, guided on out of the hollow space 15 in the inside area of the nozzle body 4 into the hollow needles 2, 3. The compressed air discharged at the front discharge end then mixes with the fluid media from the inner cannula 2, so that an exact and well-dosed application of the media is obtained on surfaces in, for example, a medical vessel 20.

This process is illustrated again in FIG. 2 in cooperation with an applying of media in a medical vessel 20 for elucidating the invention. The air and media emerging at the front discharge end of the inner cannula 2 and outer cannula 3 are redirected by 180° at the bottom of the vessel 20 and the finely vaporized droplets are evenly applied at the inside of the vessel. The discharged amount, which can be correspondingly adjusted by a dosing pump and control, is therefore distributed at the inner surfaces of the vessel 20, and the compressed air flows up and out again of the upper opening of the vessel 20. With a simultaneous moving of the device 10 with the two-substance nozzle 1 out of the inside area of the vessel 20 (cf. FIG. 4), therefore, an exact application of a predefined amount of spray at media at specific areas of inner surfaces of medical products is guaranteed in this way.

FIG. 2 shows a cross-sectional view of an embodiment of the device 10 according to the invention with two-substance nozzle 1 in a case of application for applying a fluid medical product on the inner surface of the vessel 20 in the case of application for illustrating the way of functioning and the advantages of the invention. As can clearly be seen in FIG. 2, the two-substance nozzle, moved deep into the inside of the narrow vessel 20, with the narrow inner cannula 2 and the narrow outer cannula 3 is suitable for obtaining an application and spraying of fluid media at the inner surfaces of the vessel 20 even in inner areas with narrow inner diameter. Due to the compressed air emerging through the ring gap 14 (cf. FIG. 1a) together with the media applied by means of a dosing pump from the flow passage of the inner cannula 2 a flow is caused downward and laterally upward along the inner walls of the vessel 20. Hereby, an advantageous effect according to the invention comes about: the relatively thin-walled inner cannula 2 and relatively thin-walled outer cannula 3, which have wall thicknesses in the range of, for example, 0.1 mm to 0.5 mm, are thereby automatically in each case mutually centered by the flows of air and media. This allows an exact application and spraying of well-dosed amounts of an active ingredient or medium, which can be for example a medical product like Heparin, BCA (Blood Clotting Accelerant) or EDTA (Ethylene diamine tetra acetate).

For this, the device 10 according to this embodiment in FIG. 2 has a nozzle body 4 with a central hollow space 15 for the compressed air, which flows out into the ring gap 14 between inner cannula 2 and outer cannula 3. The dimension of the ring gap 14 can be easily varied by simple exchanging of the cannulas 2, 3 with other diameters. The outer cannula 3 is held in a clamping insert 5 in the nozzle 4 by means of a clamp cap 13, wherein a secure sealing, centering and fixing of the location of the inner cannula 2 in relation to the outer cannula 3 is thereby automatically obtained. By means of such a form-fitting and force-fitting fixedly connecting of the conic shape between receiving means 7 at the nozzle body 4 and clamping insert 5, for one thing a sufficient sealing and, for another, a fixedly holding of the cannulas 2, 3 with predetermined ring gap 14 is obtained. An emerging of compressed air or fluid media is thus securely prevented.

FIG. 3 shows an enlarged cross-sectional view of the first embodiment of the device 10 according to the invention with two-substance nozzle 1 in the area of the nozzle body 4. There, the inner construction is more exactly recognizable, with two cannulas inserted one in the other 2, 3 of the nozzle body 1, which are fixedly held by means of respective clamping inserts 5, 6 at the nozzle body 4. The clamping inserts 5, 6 are preferably realized from a plastic material, so that they allow a force-fitting holding of the cannulas 2, 3 (hollow needles) and a secure sealing at the, for example, metallic nozzle body 4. The ring gap 14 hereby forms automatically between the hollow space supplied with compressed air and the front discharge end of the two-substance nozzle 1. The inlet 12 for compressed air is provided with a threaded connection-fitting, at which a compressed air hose (not shown) supplied with compressed air is connected. At the rearward end of the two-substance nozzle 1 (on the right in FIG. 3), there is a threaded fitting for the connection of a media supply in the form of a hose or the like at the inlet 11 for media, which is connected to a controllable dosing pump and control (not shown in FIG. 3). The clamping insert 5 in the first receiving means 7 has a bore or opening x1 with a first diameter d1, which corresponds at least section-wise to an outer diameter of the outer cannula 3. The other clamping insert 6 in the second receiving means 8 has an opening or bore x2 having a diameter different therefrom, the diameter d2 of which corresponds at least section-wise to the outer diameter of the inner cannula 2. Both bores x1, x2 are concentric to a common middle axis X.

By means of the method and movement of the two-substance nozzle 1 out of the inner area of the vessel 20, the supply of the media together with the supply of compressed air is controlled such that the flows are produced corresponding to the flow arrows of FIG. 2. Because of the narrow constructional shape of the cannulas 2, 3, there is enough space for the outflowing compressed air, so that no damaging high flow speeds are produced. The discharged media are hereby mixed with the compressed air at the discharge end and vaporized and applied with defined small droplets in the order of magnitude of 0.5 mm. A very exact dosing of the discharged media to be applied in the vessel 20 can thereby be obtained. In this way, the exactly adjustable spraying area in axial and radial direction is given, with very even distribution. The amounts of the sprayed-out media are for example in a variable range of 5 to 60 μl. The clamping insert 5 for the outer cannula 3 in the form of a thin-walled hollow needle and also the clamping insert 6 for the inner cannula 2 for the media, are securely fixedly held in the receiving means 7, 8 and thereby exactly fixedly held at a centralized position and location with sealing effect in the nozzle body 4. With the preferably threaded clamp caps 13, the clamping inserts 5, 6 are threadedly fixedly connected at the nozzle body, wherein thereby an effective sealing is obtained. Nevertheless, the components can be quickly disassembled again, for example for purposes of cleaning or exchanging with cannulas 2, 3 having another diameter or length.

In FIG. 4, different sequential steps A, B, C, D and E of a case of application of an embodiment of the device 10 according to the invention are shown, with two-substance nozzle 1 for the spraying of media at an inner area of medical vessels 20 in the manner of small tubes provided with a bottom. The discharge end of the two-substance nozzle 1 of the device 10 is moved into the inner space of the vessel 20 (Step A). After the moving-in and the adjusting of the starting point for the spraying of the media in the inner area of the vessel 20 (Step B), the two-substance nozzle 1 of the device 10 is gradually moved back out of the inner space of the vessel 20 simultaneously with an activating of the dosing pump for the media and of the compressed air supply for the compressed air connection 11 (cf. Step C).

In this way, due to the relatively narrow ring gap 14 of the two cannulas 2, 3, the compressed air is sprayed out and distributed with the media out of the inner area of the inner cannula 2 and applied exactly dosed onto the inner area of the vessel 20 and corresponding to the displacement movement of the device 10 (cf. steps C and D) sprayed in exactly predefined amounts according to requirement. Thereby, the spraying amount and the dimension of the fluids vaporized in droplets are very exactly adjustable and allow an optimized application of active ingredients of medical products 20 in relation to the prior art. Shortly before or after the moving-out of the device from the inner area of the vessel 20 (Step E), the dosing pump for the media is switched off and the compressed air supply is ended.

In the second embodiment of the device 10 according to the invention shown in FIG. 5 in a cross-sectional view, basically a similar construction is provided as in the first embodiment described above. Additionally, a displacement unit 16 is provided at the right-hand end in FIG. 5 for displacing the inner cannula 2 in relation to the outer cannula 3. For this, the clamping insert 6 of the inner cannula 2, which correspondingly-shaped is inserted into the conically expanded receiving means 8 at the nozzle body 4, is not clampingly held by means of a clamp cap 13, but rather by means of a kind of holding cap 17, which allows a relative displacement of the inserted displacement element 9 of the displacement unit 16, as illustrated by the arrow R in FIG. 5. The inlet 11 for the medium is realized in the inside of the displacement element 9 of the displacement unit 16. The inner cannula 2 is fixedly held at a U-shaped insert which is threadedly inserted in the holding cap 17, and together with this insert it can be correspondingly displaced by means of a servo-motor, a linear actuator or the like in the longitudinal direction of the longitudinal axis X of the device 10 as required. Thus, the relative position between the inner cannula 2 and the outer cannula 3 can be changed according to requirement and for different purposes, for example also for the fine adjusting of the spray cone. For example, in this way also different spraying profiles can be realized at the discharge end (left-hand side in FIG. 5) of the cannulas 2, 3, in that the ring gap 14 is not adjusted by cannulas 2, 3 closing aligned, but by cannulas 2, 3 slightly displaced in relation to one another. Also, for example, cleaning functions of the device 10 can be realized in this way: in the case of crusting of the front discharge end at the ring gap 14 the cannulas 2, 3 can be displaced relative to one another by means of the displacement unit 16, so that the crusted elements break off or detach themselves. Also other functions, like for example a specific dosing of medium without supply of compressed air, can be realized in this way, by displacing the inner cannular 2 forwards in relation to the outer cannula 3 and stopping the supply of compressed air by means of the inlet 12 at least for a short time. With such an embodiment, not only can different spraying profiles and further functions be realized with the device 10 without complex additional constructions, as they are described, but also, better possibilities for adaptation to the respective dimensions, shapes and givens of the medical vessels to be processed are possible in this way.

FIG. 6 in turn shows a partial cross-sectional view of a third embodiment of a device according to the invention with an alternative form of the fixedly holding of the holding caps 18 at the nozzle body 4. In this embodiment, instead of a threaded connection for fixedly holding the clamp caps 13, which is partly shown in the previous embodiments, the holding cap 18 is realized with a latching snap-lock 19, which is obtained by means of correspondingly shaped recesses and protrusions and a determined resilience in the material of the holding cap 18. By simple mounting and clipping-on of the holding cap 18 in this way the clamping insert 5 for the outer cannula 3 is fixedly held in the corresponding conical receiving means 7. With the latching snap-lock 19, a kind of pre-tension and clamping power is produced, which guarantees a secure sealing and fixedly holding of the outer cannula 3 at the nozzle body 4. An analog, corresponding kind of fixedly holding of the inner cannula can likewise be provided at the opposite, other end (not shown in FIG. 6) of the nozzle body 4. Instead of the latching snap-locks 19 represented here, other shapes of holders or holding means can also be provided for the fixedly holding of the holding caps 17, 18 or clamp caps 13. For example, instead of the threaded connections like in the first embodiment bayonet connections or spring elements can also be used, in order to guarantee the necessary clamping power and holding effect of the caps 13, 17, 18 at the nozzle body for fixedly holding the clamping inserts 5, 6. In the embodiment of FIG. 6, furthermore, as explained further below, a flanging 3.1 is provided at the rearward (inner) end of the outer cannula 3, which guarantees a fixedly holding and sliding-out of the outer cannula 3 out of the clamping insert 5. A flow directing body 21 is additionally shown in this embodiment of FIG. 6, which is mounted for aligning and harmonizing the flow speed of the compressed air for the guiding into the ring gap 14 in the hollow space 15, as is explained further below.

A fourth embodiment of a device 10 according to the invention for spraying fluid media is shown in FIG. 7 in a partial cross-sectional view. In this fourth embodiment, in the inside of the hollow space 15 of the nozzle body 4 between the inlet 12 for compressed air or pressurized gas and the inlet into the ring gap 14 at the rearward end of the outer cannula 3, a flow directing body 21 is inserted. The flow directing body 21 in this embodiment has a kind of double sleeve shape with constant cross-section. The inflowing compressed air from the inlet 12 is in this way evenly distributed and guided directed toward the ring gap, so that the most even possible compressed air production is guaranteed at the inlet of the ring gap 14 and thus all the way to the front discharge end of the cannulas 2, 3. The compressed air flows through the flow directing body 21 with the cross-section narrowed in relation to the hollow space 15, and in this way is evenly distributed and guided around the ring gap 14 exactly to the inlet between inner cannula 2 and outer cannula 3. This further improves the flow behavior and the compressed air effect in the device 10 according to the invention. Also, in this way the self-centering effect is even further improved by the narrow shape of the ring gap 14 and the relatively thin-walled inner cannulas 2 and outer cannulas 3. The cannulas 2, 3 center themselves in use due to the introduced compressed air in relation to one another and in relation to an inner space of a medical vessel 20 to be treated (cf. FIG. 2 and FIG. 4). In this example of FIG. 7, here too the outer cannula 3 is fixedly held by means of a flanging 3.1 at the rearward end behind the clamping insert 5 in the inside of the nozzle body 4. The fixedly holding of the outer cannula 3 can also have another form, for example a clamp fitting or a bonding in the bore of the clamping insert 5. The different aspects of the represented embodiments of the invention can thus as illustrated also be combined with one another so that corresponding to the requirements and the specific intended functionalities in each case, the device 10 can be variably adapted thereto.

In FIG. 8 in turn a fifth embodiment of a device 10 according to the invention for spraying or applying fluid media is shown. In this embodiment, the outer cannula 3 is fixedly held in the inside of the nozzle body, namely at the rearward end of the clamping insert 5, by means of a flanging 3.1 as a holding means. A displacement of the outer cannula 3 is securely prevented, even with high pressures on the side of the compressed air from the inlet 12. The fixedly holding of the outer cannula 3 or alternatively of the inner cannula 2 can also be realized by other means as holding means: a crimping or a bonding inside of the respective clamping inserts 5,6 is likewise thinkable. In the embodiment of the device 10 by means of which a displacement possibility of at least one of the cannulas 2, 3 is obtained, the fixedly holding of the cannulas 2, 3 is selected such that a relative displacement of the position is made possible specifically with a threaded or sliding mechanism by means of a servo-motor or the like. Thereby, the sealing off is possible in an element, also in a separate element, to the clamping inserts 5, 6, in which then the fixedly holding for producing the displacement possibility takes place.

The shown different aspects of the invention can also be combined with one another, as is partly already shown by means of the variants of the shown embodiments in connection with the drawings. In particular, the kind and the form of the fixedly holding of the inner cannula 2 and the outer cannula 3 can vary. For this, holding caps 17, 18 and also clamp caps 13 can be used. Also, the basic construction of the nozzle body 4 can be formed either symmetric, as partly shown in the Figures of the embodiments. Also an asymmetric shape of nozzle bodies 4 and of the device 10 altogether is thinkable, for example when a protruding holding flange is required on one side for the mounting at adjacent components. Also, in alternative embodiments of the invention the shape of the clamping inserts 5, 6 can be provided other than with the linear conical shape in the way of a truncated cone, as long as the outer cannula 3 and the inner cannula 2 are fixedly held and mounted in the inside of the nozzle body 4 for producing a defined and securely fixedly held ring gap 14.

As a pressure means for the manufacturing of the vaporization, partly, compressed air is described. Other types of pressurized gases or auxiliary gases can also be used in the scope of the invention. For example, in determined cases of application an inert gas can be used in order to cause an as small as possible reaction with the environment by the pressurized gas. Thus, for example CO₂ can be used in order to obtain an O₂-reactively-poor environment in the spraying environment of the device 10, which is important in determined medical cases of application.

1. A device for spraying or applying a medium using an auxiliary gas in the form of compressed air or inert gas under pressure, in particular at insides of medical products or vessels, the device comprising:
a two-substance nozzle formed from at least two cannulas inserted one in the other, with substantially constant diameter along their longitudinal extension;
a nozzle body formed as a holding means for the two-substance nozzle, which has at least in each case an inlet for the medium and for the auxiliary gas; and
clamping inserts at the nozzle body, the clamping inserts adapted to receiving means are arranged for a sealingly holding and fixedly holding of an inner cannula and of an outer cannula, wherein the clamping inserts are provided for attaching the cannulas inserted one in the other with the formation of a predefined gap between inner cannula and outer cannula.

2. The device according to claim 1, wherein the clamping inserts have a conically tapered shape and the nozzle body has correspondingly conically shaped receiving means.

3. The device according to claim 1, wherein the cannulas inserted one in the other are relatively thin-walled hollow needles with a wall thickness of 20% to 30% of the inner diameter of the cannulas.

4. The device according to claim 1, wherein the gap or ring gap for compressed air or inert gas between the inner cannula and the outer cannula has a dimension of less than 10%, preferably 6%, of the diameter of the inner cannula.

5. The device according to claim 1, wherein at least one of the clamping inserts is fixedly held by means of a clamp cap, in particular threadingly clamp cap, at the nozzle body.

6. The device according to claim 1, wherein the inner cannula and the outer cannula are arranged at the front-end discharge end aligned or flush with one another.

7. The device according to claim 1, wherein the relative position of front-end discharge ends of the inner cannula and the outer cannula is adjustable.

8. The device according to claim 1, wherein a hollow space is provided in the nozzle body for supplying compressed air or inert gas into the two-substance nozzle.

9. The device according to claim 1, wherein the cannulas are provided as hollow needles, wherein the hollow needles of the cannulas are thin-walled in the range of wall thicknesses between 0.1 mm to 0.5 mm.

10. The device according to claim 1, wherein at the nozzle body in relation to the longitudinal direction of the cannulas a laterally arranged connection for compressed air is provided.

11. The device according to claim 1, wherein the clamp cap on the side of the cannulas is outside conically tapered.

12. The device according to claim 1, wherein the clamping inserts are adapted for centering the cannulas of the two-substance nozzle in relation to a middle axis of the nozzle body.

13. The device according to claim 1, wherein a displacement unit is provided at least one of the inner cannula and the outer cannula, for displacement of the relative position between the cannulas.

14. The device according to claim 1, wherein by means of a holding cap with a displacement element which is displaceable in longitudinal direction of a middle axis, at least one of the clamping inserts is fixedly held at the nozzle body such that the relative position between the cannulas is changeable.

15. The device according to claim 1, wherein the clamping inserts in the receiving means are centered and sealingly fixedly held by means of holding caps, which are held at the nozzle body by a resilient spring, a bayonet lock or a latching snap-lock.

16. The device according to claim 1, wherein at least one of the cannulas is held fixedly connected at the clamping inserts by means of an end-side holding means, in particular by a flanging, crimping or bonding.

17. The device according to claim 1, wherein an air guide element or flow directing element for the compressed air or an inert gas under pressure is provided in the nozzle body.

18. The device according to claim 1, wherein a first receiving means or clamping insert has an opening or bore, the diameter of which corresponds at least section-wise to an outer diameter of the outer cannula, wherein a second receiving means or clamping insert has an opening or bore, the diameter of which is different from the diameter of the first receiving means and corresponds at least section-wise to an outer diameter of the inner cannula, and wherein the bores are arranged in particular concentrically in relation to a common middle axis.

19. A device for spraying or applying fluid media in the form of compressed air supply or by means of pressurized gas, in particular at insides of medical products or vessels, the device comprising:
a two-substance nozzle formed from at least two cannulas inserted one in the other with substantially constant diameter along their longitudinal extension;
a nozzle body formed as a holding means for the two-substance nozzle, which has in each case at least an inlet for the medium and for compressed air or an inert gas; and
clamping inserts at the nozzle body, the clamping inserts respectively adapted in shape to receiving means are provided for a sealingly fixedly holding of an inner cannula for media and of an outer cannula for compressed air in the form of hollow needles, which are provided for attaching the cannulas inserted one in the other with the formation of a predefined gap between inner cannula and outer cannula in the correspondingly-shaped receiving means.
